(19) United States
(12) Patent Application Publication
(10) Pub. No.: US 2009/0083164 A1
(43) Pub. Date: Mar. 26, 2009

(54) LIGHTWEIGHT SEARCHABLE POINT-OF-SALE MECHANISM FOR LEVERAGING INTERACTIVE COMMUNITIES

(75) Inventors: Jackson Robie Hull, Redwood City, CA (US); Ed Shirey, Park City, UT (US); Calbert Lai, Mountain View, CA (US); Eric Hassman, San Francisco, CA (US)

Correspondence Address: Leason Ellis LLP, 81 Main Street, Suite 503, White Plains, NY, 10601, US

(73) Assignee: Sitoa, Inc., San Mateo, CA (US)

(21) Appl. No.: 12/238,616

(22) Filed: Sep. 26, 2008

Related U.S. Application Data
(60) Provisional application No. 60/975,501, filed on Sep. 26, 2007.

(51) Int. Cl. G06Q 30/00; G06F 7/06; G06F 3/048; G06Q 99/00; G06F 17/30

(52) U.S. Cl. 705/27; 707/4; 715/786; 715/780; 715/809; 707/E17.016

(57) ABSTRACT

A software component comprises a plurality of modules each executing in a browser environment to make use of “friends” data in a networking site for data gathering and filtering in support of e-commerce through the networking site. A user-interface module operates to output catalog information to the logged-in user and to capture any input. Meanwhile, a data cache or memory is accessible to the modules and is configured to store the catalog information. A control module responds to any input captured at the user-interface so as to provide the catalog information to the user-interface, wherein the catalog data is typically provided from the data cache. A discovery module operates to identify any friends associated with the logged-in user. A communications module operates to populate the data cache with any catalog information retrieved from the server that is associated with the logged-in user and/or any discovered friends.

This application claims priority pursuant to 35 U.S.C. § 119 from Provisional Patent Application Ser. No. 60/975,501, entitled “Lightweight Searchable Point-Of-Sale Mechanism For Leveraging Interactive Communities,” filed Sep. 26, 2008, which is hereby incorporated by reference in its entirety.

### FIELD OF THE INVENTION

The present invention relates to software-based applications and more particularly relates to a software component that is embeddable into another application to provide e-commerce facilities to the user for personal ecommerce and ecommerce transactions for members in the community.

### BACKGROUND OF THE INVENTION

There are a number of websites that are not configured to support e-commerce, yet which have vast communities of users who congregate based on common interests or goals. In many cases, members of such online communities choose or pre-approve other members before allowing such other members access to information on the member's page(s). Such web sites are referred to as a “social networking” sites, and more generally are “networking” sites. Examples of networking site include but are not limited to MySpace, Facebook, and LinkedIn. Some networking websites have introduced APIs to enable programs to create applications that can be embedded into user-profiles or pages.

The popular applications that have been embedded into the user-profiles of networking sites are those that assist with managing photos, videos and calendars. These applications tie in to the central concept of sharing information among the members of the networking site. However, e-commerce engines have not been provided as embedded applications that have leveraged the social aspects of networking sites.

The traditional e-commerce engine is not practical for networking sites because the interface consumes the entire display, and the results tend to be displayed in a vertical page, similar in concept to a paper catalog. This mechanism is not optimal when the catalog search is part of another application (i.e., embedded) because the results cannot easily be viewed within a constrained amount of space allocated to the embedded program. Likewise, the traditional e-commerce configuration presents difficulties to the viewer when the browser view is limited such as when viewing the webpage from a mobile device.

What is needed in the art is a way to reduce the screen or web-page real-estate utilized by an c-commerce application so as to occupy limited vertical space. What is further needed is a software component that can make use of the social aspects of networking sites in furtherance of facilitating e-commerce transactions for the benefit of online community members. Embodiments of the present invention address one or more of these needs.

### SUMMARY OF THE INVENTION

In accordance with a broad aspect of the invention, a software component provides a plurality of module that cooperate within a browser environment to leverage “friends” data maintained by a networking site so as to provide a basis for data gathering and tailored presentation to the networking site user in support of c-commerce through the networking site. “Friends” are those other members of a community that the logged-in user is associated with either in a group of users within the community, or as manually identified community members. The component discovers “friends” of the logged-in user, determines whether they have created wish-list or want-list entries, and conveys this information back to the logged-in user, within the component, in a manner that enables the logged-in user to review such list entries and make purchases for the benefit of their “friends.”

In accordance with a more particular aspect of the invention, a computer-based system adds shopping-functionality to logged-in users of a networking site. The functionality is provided in a browser environment on a machine used to access the networking site. The system comprises a software component that has a plurality of modules, each of which executes in the browser environment. A user-interface module operates to output catalog information to the logged-in user and to capture any input. Meanwhile, a data cache or memory is accessible to the modules and is configured to store the catalog information, including one or more subsets of catalog data such as data relating to deals being offered or the wish-lists and want-lists of “friends” of the logged-in user. A control module responds to any input captured at the user-interface so as to provide the catalog information to the user-interface, wherein the catalog data is typically provided from the data cache. A discovery module operates to identify any friends associated with the logged-in user. A communications module operates to populate the data cache with any catalog information retrieved from the server that is associated with the logged-in user and/or any discovered friends.

In further aspects, the software component can further have an ecommerce module that is responsive to interaction with purchase controls provided through the user-interface to initiate a purchase transaction with the logged-in user.

These and further aspects, features and advantages of the present invention will become more apparent from the following detailed description when taken in connection with the accompanying drawings which show, for purposes of illustration only, a preferred embodiment of the present invention.

### BRIEF DESCRIPTION OF THE DRAWING FIGURES

FIG. 1 is an illustration of one embodiment of a software component operative in accordance with certain aspects of the invention;

FIGS. 2A through 2D illustrate aspects of another embodiment of the a software component that can be embedded within a networking site;

FIG. 3 is a flow diagram illustrating the operation of the software component as an embedded component within a website;

FIG. 4 is a flow diagram illustrating certain events that can be processed by a software component embedded within a website;

FIG. 5A is an example of a user-interface for a software component operative in accordance with certain aspects of the invention illustrating certain aspects of the interface;

FIG. 5B is the example of FIG. 5A now showing the user-interface having pulled in information in response to information being provided in a text box;

FIG. 5C is an example of a pop-up dialog box that can be provided by a software component operative in accordance with certain aspects of the invention; and

FIG. 6 is a schematic block diagram of the basic modules that define a software component in accordance with one embodiment of the invention.

### DETAILED DESCRIPTION OF CERTAIN EMBODIMENTS OF THE INVENTION

By way of overview and introduction, the software application of the present invention provides a lightweight tool for inclusion in web-pages and browser-based applications. The software application supports both product-search and product-payment functionalities from within the boundaries of its deployment. As a result, inclusion of the software product within a webpage or other application provides enhanced and advanced functionality to interactive communities and other pages that would benefit from having a point-of-sale pushed to the page of interest. Meanwhile, the advanced product finder (“APF”) application arranges and manages the interaction within the confines of a small visual display panel using simple controls. As such, the APF application provides a mechanism for a “push sale” that is particularly effective in increasing product visibility, advertising, and availability in any number of e-commerce transactions, including inventory-less transactions as described in co-pending applications assigned to the present assignee. As described more completely below, the APF includes navigation controls that are configured to guide the user to particular products and subcategories within the catalog.

Preferably the APF comprises a computer software application that is coded in a browser-supported language (such as HTML, JavaScript, Java, etc.). Such programs, sometimes referred to as web applications or “webapps” rely upon a common web browser to render the application executable. For instance, the APF webapp can comprise an AJAX (Asynchronous JavaScript and XML) application that retrieves data from a server asynchronously in the background without interfering with the display and behavior of the page of the networking site. As used herein, the term “AJAX” is more broadly intended to cover any web-compliant language or script that permits asynchronous interaction with a remote server.

The APF is deployed in the browser of a machine being used by the user, and since the APF executes within the browser of the client machine, it is machine agnostic. The APF can call a PHP, C+ or Perl script to cause the server to write catalog information into a MySQL table or another table structure. The table can be maintained in a data cache of the APF, and the data that is written to the data cache preferably includes several tables, each including sets of product offerings available for purchase from the entity operating the server, or from third parties as in an inventory-less transaction as described in applicant's co-pending applications. Thus, one table can include deals that have been identified for highlighting under a “deals” tab within a user-interface of the APF. Another table can include specially priced products under a suitably identified tab within the user-interface of the APF. Still another table can include prior wish-list and want-list selections of the user who has logged-in to a networking site or elsewhere, and in accordance with a salient aspect of the present invention, another table can be populated with the wish-list/want-list selections of other members of the community hosted by the networking site, and more preferably of such other members who have been identified by the logged-in user as his or her friends. That is to say, “friends” are those other members of a community that the logged-in user is associated with either in a group of users within the community, or as manually identified community members.

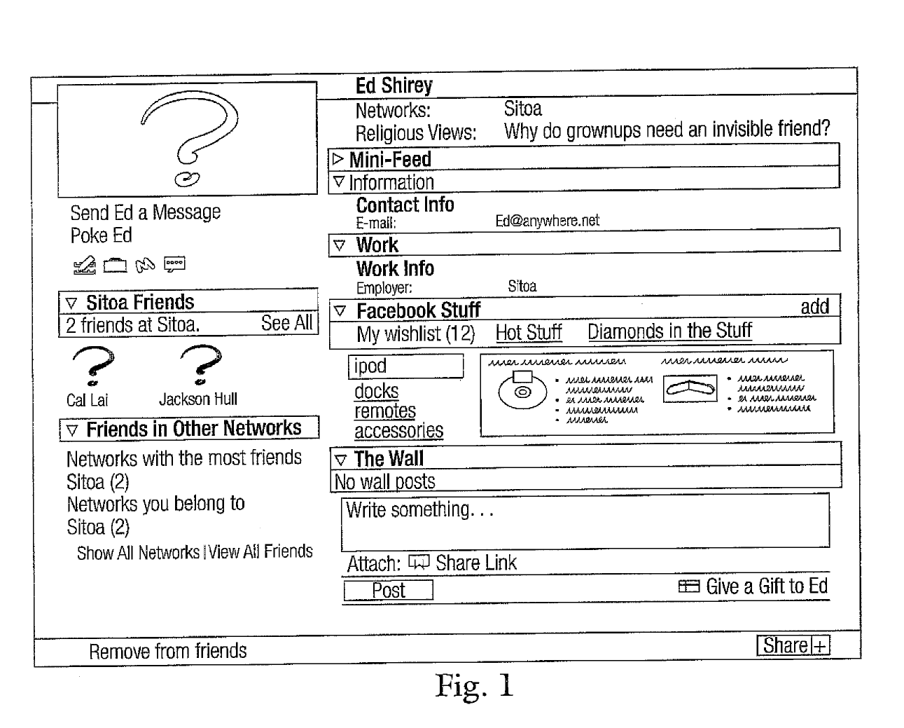

FIG. 1 illustrates an embodiment of the APF 100 that is embedded within a networking site user-profile page in which catalog data is scrollable to output and thereby display the logged-in user's wish-list, new items (“hot stuff”) and to provide a hierarchical menu of product choices (“ipod,” and the subcategories docks, remotes, and accessories).

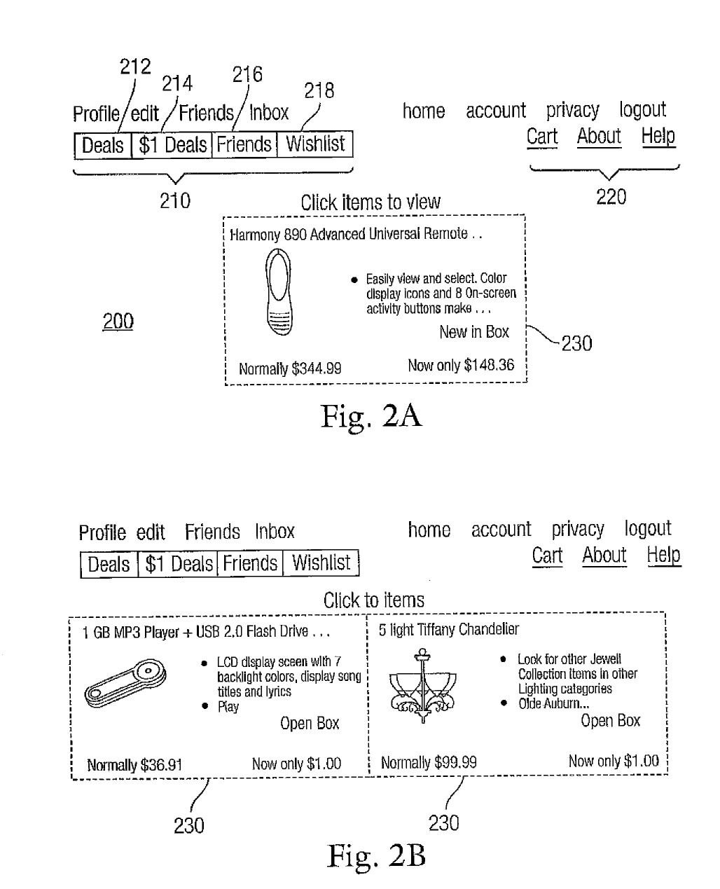

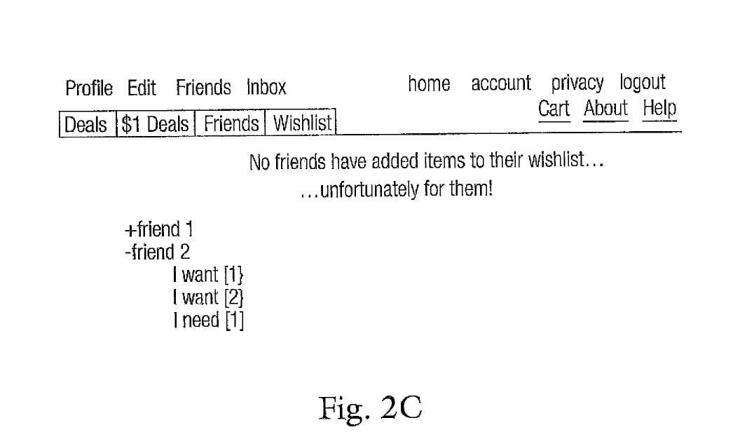

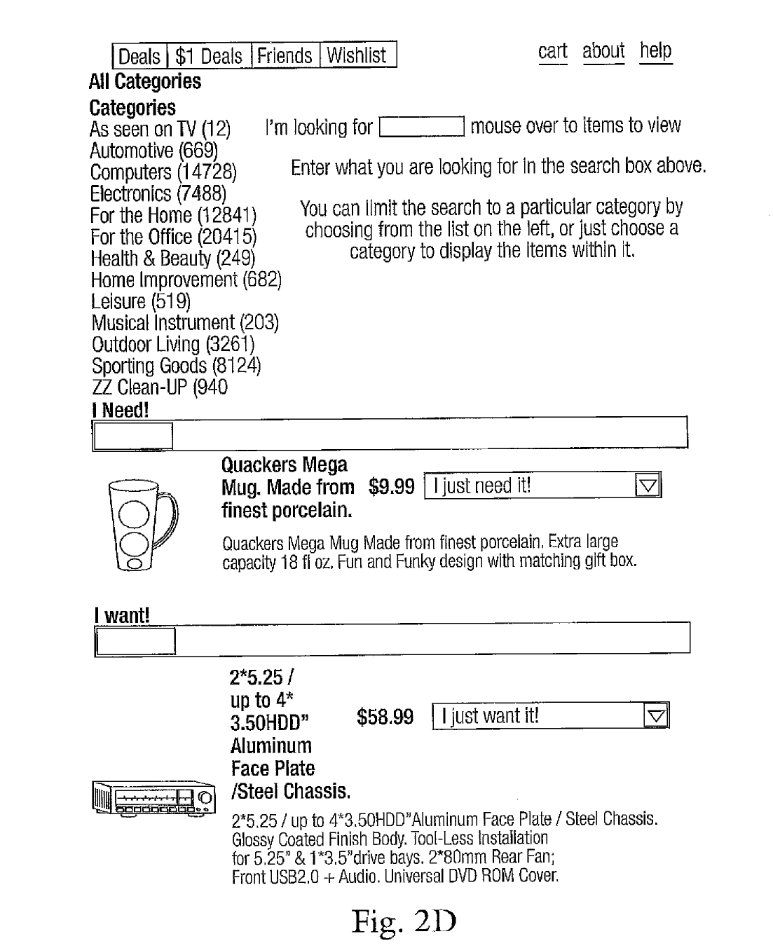

FIGS. 2A through 2D illustrate another embodiment of a software component APF, APF 200, which is embedded within a networking site. The APF 200 includes a set of navigation controls 210 that are configured to cause the user-interface of the component to output different catalog data as a function of which control has been selected. In particular, control 212 (“Deals”) causes the user-interface to display certain products that the entity controlling the server has elected to highlight. Thus, in FIG. 2A, a new-in-box remote control available at a considerable discount is the only item that is highlighted, when control 212 is selected (as shown). The user can click on the highlighted product to cause further information to be displayed, preferably, within a pop-up dialog box that has further product details and further controls that permit purchase or wish-listing of the item, as discussed further below. Control 214 (“$1 Deals”) can be provided to cause the user-interface to display certain products that are on special, again, as selected by the entity controlling the server as a product to highlight in this way. Thus, in FIG. 2B, there are two open-box items available for selection, both at enticing price points. Again, clicking upon a product preferably causes further product details and e-commerce controls to be presented. FIGS. 2C and 2D illustrate the user-interface when the “Friends” and “Wishlist” controls 216, 218 are selected, respectively. As illustrated in FIG. 2C, there are no “friends” of this logged-in user that have wish-lists. Yet, the logged-in user has selected products that he or she wants or needs, and the catalog data corresponding to those selections is retrieved from the server and pushed into the APF 200 for display through the user-interface, as illustrated.

The display of FIG. 2C is automatically updated to include the wish-list items of other community members that are among the “friends” of the logged-in user. Thus, if the logged-in user having the wish-list of FIG. 2D were a friend of another user having the APF 200 plug-in, then when that other user logs in, the selections in FIG. 2D would appear for that user as the wish-list items of a friend.

At the back-end, the embodiments of FIGS. 1 and 2 can be implemented using a variety of operating systems and web servers since. In an implementation of one embodiment, for example, a Linux operating system running an Apache Web Server can comprise the back-end server that communicates with the APFs 100, 200 to provide the catalog data and respond to e-commerce transaction requests.

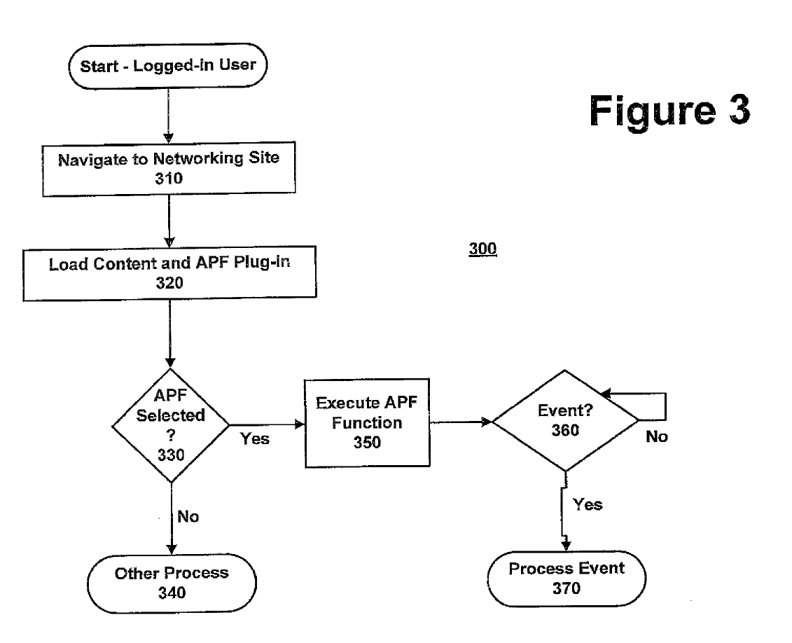

Referring now to FIG. 3, a user of a networking website, for instance, navigates his or her browser to the home page or log-in page of the site, as indicated at block 310. The browser can be any commercial browser such as the latest version of Internet Explorer or Mozilla. The browser then loads content from the site as well as the APF plug-in, as indicated at block 320. The plug-in executes within the browser environment using a browser-compliant language, script, or both. At block 330, a test is made to determine whether functionality provided by the APF has been selected. If it has not been selected then other processes are performed, as generally indicated at terminator block 340. On the other hand, if an APF function has been selected, such as to present “hot stuff” using control 120 or to show “$1 Deals” using control 214, then the APF function is performed by the APF, as indicated at block 350. Depending on the APF function, the software component may wait for a further event, as indicated by the loop at block 360. Such an event might be to cause a pop-up dialog box with further product information, or a change in the user-interface display in response to selecting a different control (e.g., the user selecting the “Friends” control 216). Until such event occurs, the component is active and awaits the event. Meanwhile, the remainder of the page can be updated or otherwise operate without hindrance by the component. When an event is detected, as tested at block 360, then the event is processed as indicated by terminator block 370. Of course, the flow diagram is provided to illustrate the general concept of the embedded component whereas in any practical implementation, the tests at blocks 330 and 360 will be detected as events at a keyboard or mouse or other input device under control of the user.

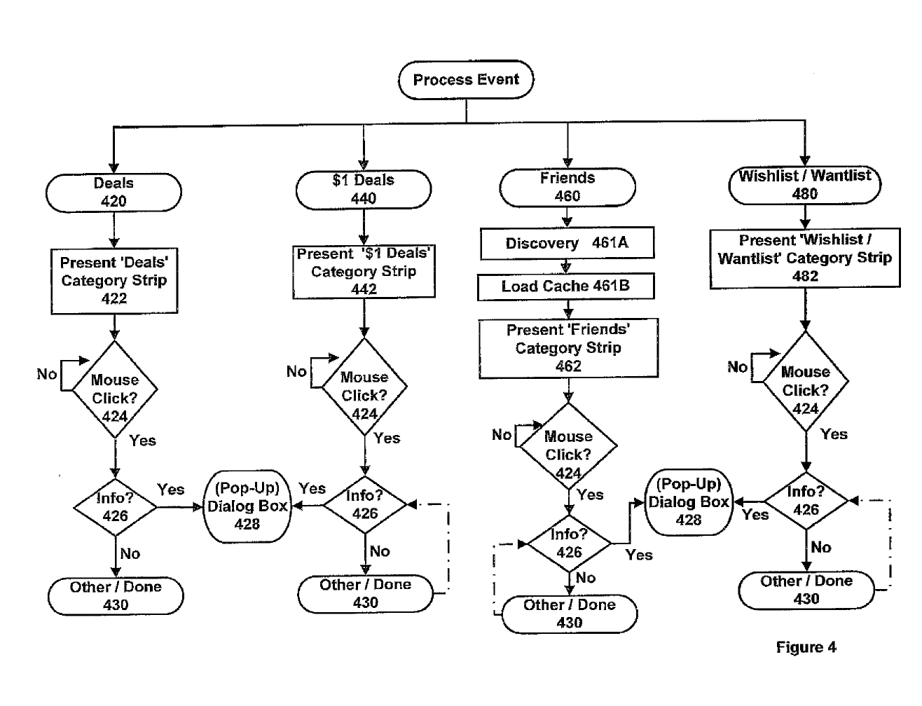

FIG. 4 illustrates certain events that can be processed by a software component embedded within a website. Fewer or additional events can be processed depending on the configuration of the APF. The processes illustrated in FIG. 4 correspond to functions that can be implemented in response to selection of controls 212-218 of FIG. 2A.

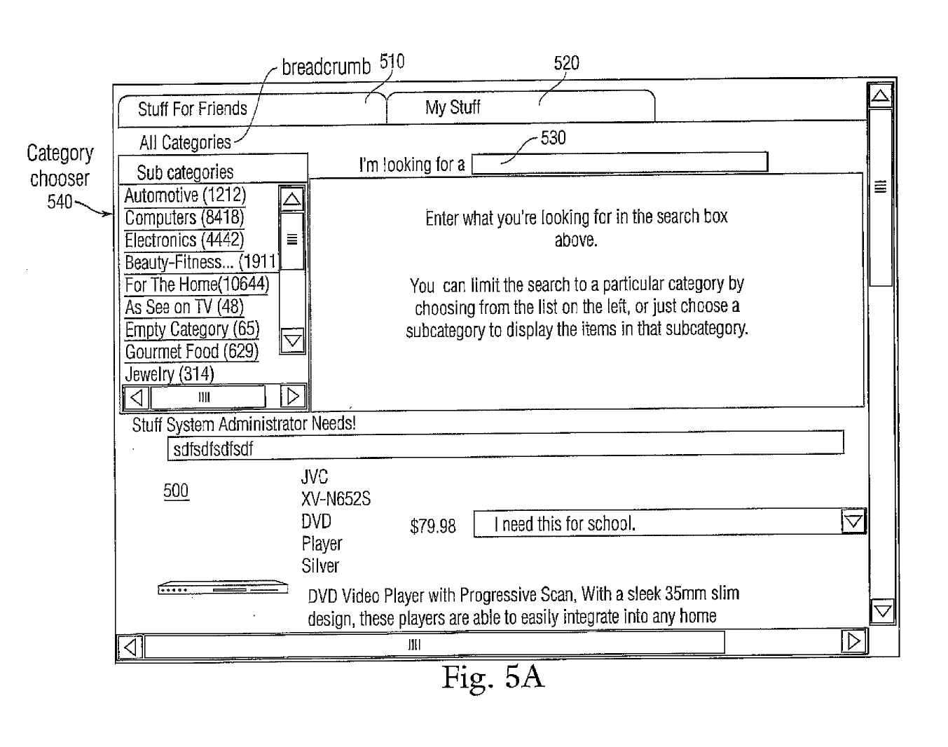

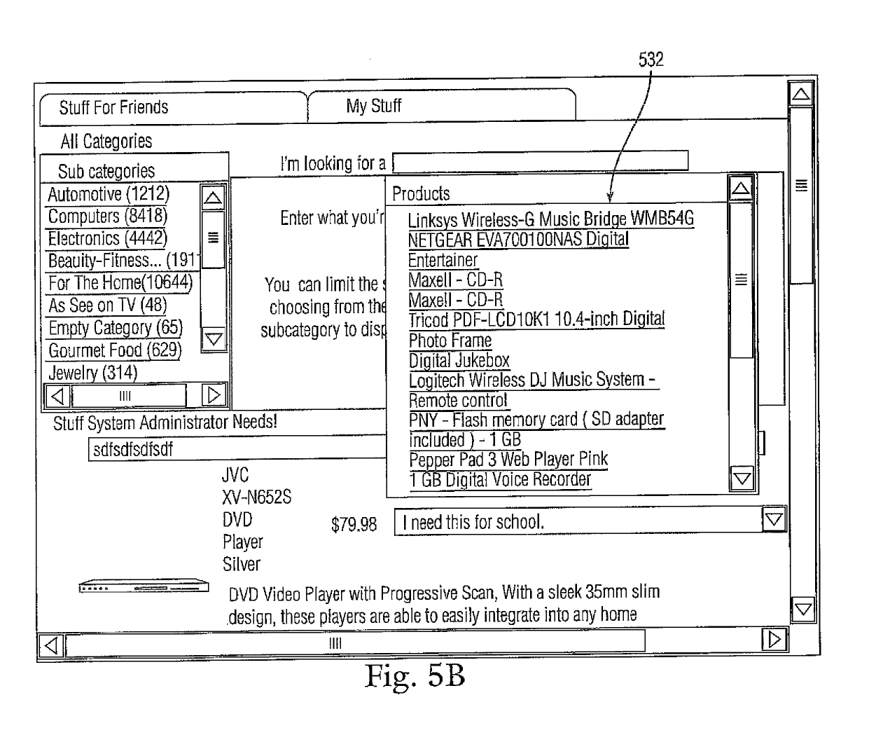

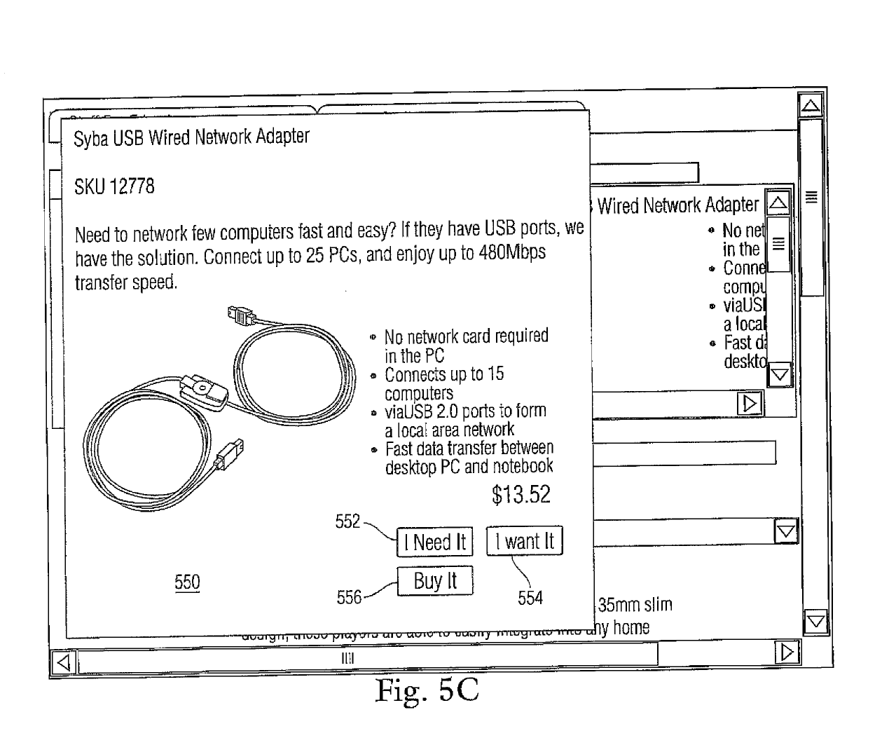

If control 212 (“Deals”) is selected through the user-interface, the APF will capture that input and cause the deals branch 420 to be executed. Execution of the deals branch 420 can include execution of software code (generally referred to as “modules”) that is unique to this branch of the flow diagram, or can comprise execution of code that is common to several branches yet that has parameters or values defined that influence operation of the code. At block 422, a category strip is output through the user-interface and presented to the user. The catalog strip generally comprises at least one product that is to be displayed to the user for selection. In FIG. 2A, for instance, there is one product to display and so execution of the code at block 422 causes a category strip to display a single product and no other category members. The product is included in the category strip preferably because it has been loaded in a data cache of the APF based on data delivered from a server of the entity that is hosting the APF and providing the e-commerce functionality. The output of the user-interface will remain in this state until the user takes some action, as indicated by the test at block 424 to determine whether there has been a mouse-click event. As will be understood, other events can be tested in addition to or in lieu of detecting mouse-clicks. The APF presents the product and the expectation is that sometimes the user will have an interest in the product and wish to see more information, add it to a wish-list or a want-list or wish to purchase it. Various actions by the user can be detected, preferably as dynamic events through the user-interface, but in relevant part, a test is performed to determine whether the user has interacted with the product in the category strip, as indicated at block 426. Such interaction can be, for instance, a mouse click on the product or within the contours 230 that surround the product. If the user has interacted with the product, then a dialog box can be presented, such as shown in FIG. 5C, to provide the user with further information about the product and enable the user to add it to a wish-list or a want-list or wish to purchase it using controls included in that dialog box. Preferably, the dialog box is of the pop-up variety that can be closed using a conventional close-box. On the other hand, if the interaction is not with the product, then some other action can be taken, as indicated at block 430. Depending on the action taken by the user through the user-interface, further events can again be detected at block 426, or the actions may not concern execution of the APF at all, such as when the user interacts with other features of the host site.

If control 214 (“$1 Deals”) is selected through the user-interface, the APF will capture that input and cause the deals branch 440 to be executed. Execution of branch 440 can be substantially the same as branch 420, except that the category strip output through the user-interface will include one or more products preferably taken from a data cache of the APF that have been maintained in the “$1 Deal” category. Likewise, selection of control 218 invokes process branch 480 which causes the catalog information associated with the logged-in user's wish-list and want-list to be retrieved from a data cache based on prior-selections of the logged-in user. The blocks in these flow diagrams can otherwise be as shown in branch 420 and are not described further.

On the other hand, if the control 216 (“Friends”) is selected, the APF performs additional steps related to discovering the friend-relationships of the logged-in user within the community of the networking site. As indicated at block 461A, these relationships are discovered using dynamic or active code elements that operate to identify the friends associated with the logged-in user. The code elements can comprise scripts or executable code that are used to identify the username of the logged-in user's friends. For instance, the API provided by some networking sites such as Facebook and MySpace as two examples, are configured to respond to requests for information in a user-profile, including the list of friends of the logged-in user. Once the usernames have been identified, server calls are made to obtain the wish- and want-lists of such friends and this information is then loaded into the data cache of the APF, as indicated at block 461B. Alternatively, the server can return a filtered set of friends among the logged-in user's friends that are determined to have any wish-list or want-list items. The user-interface of the APF can present the names in an expandable list to permit the logged-in user to review the filtered names and selectively expand any of the names (such as Friend 2 in FIG. 2C) to display the want-list and wish-list items of that friend.

The server that communicates with the APF stores any wish-list and want-list items of each user who has downloaded the plug-in and availed himself or herself of this feature. Thus, the server is able to upload to the data cache of the APF of the logged-in user any wish-list and want-list items of friends of the logged-in user who have the APF installed in the user-profile and who also have wish-list and want-list items.

The remainder of the flow diagram proceeds as previously described, except that execution of branch 460 has the category strip output through the user-interface including one or more products that are in the wish- and want-lists of the friends of the logged-in user. In this way, the logged-in user can rapidly choose and even purchase gift items and necessities for other persons in their networking community.

In FIG. 5A, an example of the user-interface 500 is illustrated in which tabs 510, 520 are provided to immediately display the logged-in user's selections (“My Stuff”) and the selections of the logged-in user's friends (“Stuff for Friends”). In addition, there is a Category heading and a hierarchy of subheadings that generate breadcrumbs to permit the user to navigate backwards from a leaf node toward the starting category point using conventional hyperlinks.

In addition, a search field 530 is provided in the form of a text box that can receive text for searching against the product database. The catalog can be searched using the information entered in this field. This search is performed dynamically by communicating with server, for example using AJAX. The searching can be performed at varying frequencies and optionally in response to various conditions, as discussed below. The products displayed in the product finder window can be selected and determined by the contents of the search field, or the APF can update the contents of the product display as the user is typing in the search field. That is, as the user enters each word or letter, the widget can contact the server and search the catalog based on the updated search. Alternatively, the products displayed in the product finder window can also be determined in response to the content of the web page (or screen) in which the widget is embedded. That is, the contents of the web page can be parsed and examined for keywords or other known metrics. The results of this analysis can then be used to search the catalog for relevant products.

The results of the search can be displayed in a popup window, frame, or area 532 (predefined or dynamically resizable) directly beneath the search field, with the top product choices listed, as shown in FIG. 5B. This list is limited to a small number (e.g., 10), based on the application or user preferences. The categories that contain the displayed items can also be listed, beneath the top product list. The user can select a product or a category within this list. If the user selects a category, the contents of the catalog strip are updated to reflect this choice. If the user selects an item, the catalog strip is updated to show all the items within the category containing the selected item, and the selected item's details are displayed in a popup window.

Instead of using the search box, the user can interact with a category chooser 540 that is preferably displayed alongside the search box 530. It corresponds to the typical category list in an c-commerce application, but in a condensed form. The contents of the chooser can scroll within the defined vertical limits, and optionally horizontal limits, of the APF component. The user may select a category, making it the current category, and affect the presentation of the category breadcrumb and catalog strip. The search can also be limited to the current selected category as a result.

As discussed above, the catalog strip allows the APF to provide a full catalog listing while still working effectively within a limited vertical page space. The catalog strip can display each product within the current category in a horizontally scrolling area, with each item displayed in a condensed format. This format preferably uses a small image coupled with a brief description to provide effective browsing with limited space. The user may scroll the catalog strip by using the horizontal scroll bar. By clicking and dragging the scroll bar thumb area, the user can smoothly glide through each of the products, even though there may be hundreds displayed. As a result, the catalog items are displayed in a horizontally scrolling area, using a minimum of vertical page space. The user may hover over a particular item or click on it, resulting in a popup containing more item details and a larger picture, as described at block 428. This popup is effectively a “zoom” view of the product. FIG. 5C provides one example of a popup 550 within the context of the embodiment being discussed. The user can simply hover over a different product to view its details, or close the zoom view by clicking the popup. As well, the pop up preferably includes e-commerce controls 552, 554, 556 to enable a purchase transaction to be commenced and to enable products to be added to wish- and want-lists. Interaction with the controls 552, 554, 556 directs the user to a conventional e-commerce engine for capturing billing and shipping information of the user. The effect of the catalog strip is that of a large film clip that can be scrolled into view as needed. As the user hovers over an area of the strip, the product is zoomed, comes into focus, automatically.

The leveraging interactive communities to display catalog products that are of interest or targeted toward members of the community hosting the widget (i.e., community members including the widget on their web page) or the community members viewing the widget. Thus, the APF can create a suggesting sale or push sale by targeting and leveraging the viral or social network.

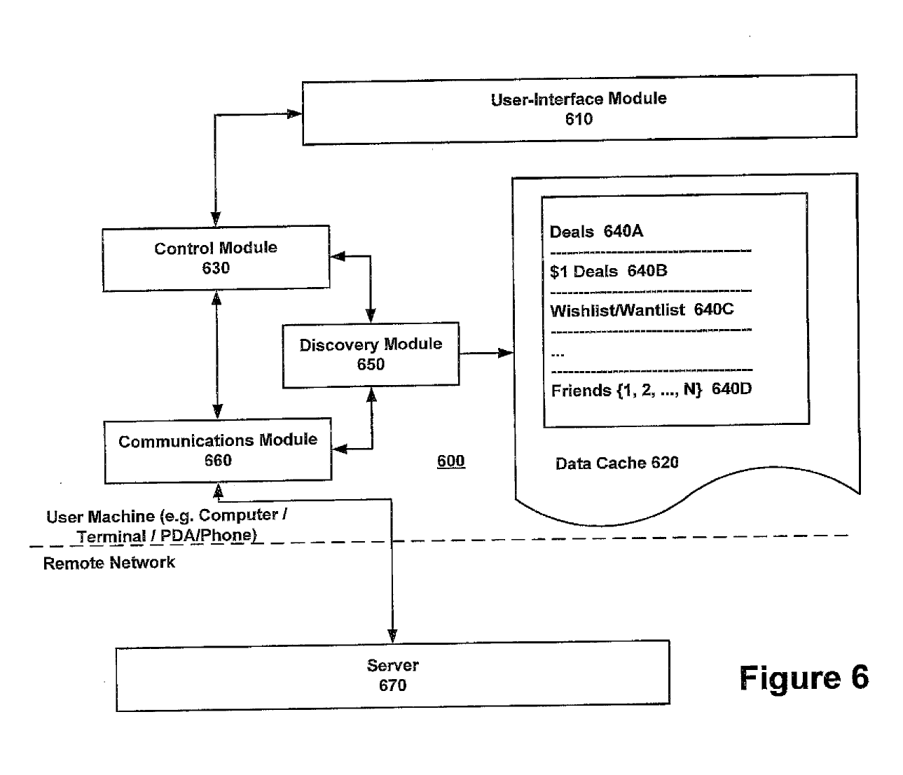

FIG. 6 is a schematic block diagram of the basic modules that define a software component in accordance with one embodiment of the invention. An APF 600 (which can be the same as APF 100 and 200) generally comprises a plurality of modules that each execute in a browser environment on a machine of a user. Preferably, the user is logged-in to a networking site or another social venue so that the component can interact with its environment and use some of that information to construct a catalog strip for display to the user. More preferably, the site is a networking site and the information used to construct the catalog strip is the set of friends associated with the user.

The APF 600 includes a user-interface module 610 operative to output catalog information to the logged-in user and to capture inputs by the user. As described above, the inputs that can be captured include text strings through the text box 530, category selections through the category chooser 540 and previously selected data using the controls 510, 520. A data cache 620 is accessible to all or some of the modules and is configured to store the catalog information, such as information that is received from a server that is supporting c-commerce transactions through the APF. A control module 630 responds to inputs captured at the user-interface and provides the pertinent catalog information 640A, 640B, 640C, . . . , 640D to the user-interface 610 from the data cache. Thus, the catalog information that is provided to the user-interface will vary depending on the processing branch taken, as described above in connection with FIG. 4. A discovery module 650 operates to identify any friends associated with the logged-in user, and this information is pulled from the server into the data cache 620 or directly through the user interface 610. Preferably, a communications module 660 operates to populate the data cache or user-interface with the pertinent catalog information that is retrieved from the server 670.

APF provides many benefits as a lightweight shopping widget. These benefits include the ability to deploy directly into the profiles of members of social or viral networks, thus taking the point of sale to the consumer, rather than having the consumer come to the point of sale. The widget can also put deep product assortment directly into the hands of consumers on a mobile handset and create a point-of-sale mechanism that does not require a high-density, high-bandwidth storefront that can be deployed as close to the consumer as possible. Thus, the APF can create a sales mechanism for a “push sale” rather than a “pull sale.”

In an inventory-less transaction model, the lightweight shopping widget can access communities of consumers through opportunistic leveraging of retail and social websites. The viral network connects consumers with products anywhere they may gather. Subsequent or resulting sales of these items can be sourced and fulfilled in an inventory-less manner.

The Lightweight Shopping Widget and Light-Footprint Product Search use lightweight, minimum-refresh technology that minimizes bandwidth requirements and is based on a service architecture. The approach is social and consultative selling by including friends, wish lists, gifts, and reviews. It is ideally suited for non-traditional e-commerce platforms such as Social networking sites (e.g., facebook), mobile applications including on-deck or off-deck and WAP or mobile application.

By integrating with social networking sites, or utilizing an API of a social networking site, the Lightweight Shopping Widget can provide immediate, clickable access to a product catalog. The community-based network allows users to suggest gifts, “pitch in” for friends, etc. Further, the integration, or embedding (as illustrated below), provides nearly instant marketing of “Hot” products.

In a further aspect of the invention, the APF can cooperate with a registration site that is independent of the networking sites to which the APF is downloaded and/or associated. The registration site is configured to maintain records of plural user-profiles of the same user. In other words, if Jim has a profile on the networking sites MySpace and LinkedIn, any friends of Jim on either of these sites can be discovered and the wish-list and want-list items across a wider spectrum of sites can be integrated and pulled into the data cache of the APF regardless of which site Jim happens to be viewing the APF.

While the invention has been described in connection with a certain embodiment thereof, the invention is not limited to the described embodiments but rather is more broadly defined by the recitations in the claims below and equivalents thereof.

We claim:

1. A computer-based system for adding shopping functionality to a logged-in user of a networking site that is provided in a browser environment on a machine, comprising a software component having a plurality of modules each executing in the browser environment including:
a user-interface module operative to output catalog information to the logged-in user and to capture any input;
a data cache accessible to the plurality of modules and configured to store the catalog information;
a control module responsive to any input captured at the user-interface so as to provide the catalog information to the user-interface from the data cache;
a discovery module operative to identify any friends associated with the logged-in user;
a communications module operative to populate the data cache with any catalog information retrieved from the server that is associated with (i) the logged-in user, (ii) any discovered friends, or (iii) both the logged-in user and any discovered friends.

2. The computer-based system of claim 1, further comprising an ecommerce module responsive to purchase-requests input by the logged-in user through the user-interface.

3. The computer-based system of claim 2, wherein the purchase requests are conveyed by the communications module to the server for fulfillment.

4. The computer-based system of claim 3, wherein the purchases are fulfilled in an inventory-less manner.

5. The computer-based system of claim 1, wherein the user-interface outputs the catalog information as a scrollable strip of products, wherein the scrollable strip is arranged in the output of the user-interface as an array having one row of products.

6. The computer-based system of claim 5, wherein the user-interface includes a scroll control to navigate the scrollable strip of products.

7. The computer-based system of claim 6, further comprising
an ecommerce module; and
a dialog box responsive to interaction with one of the products in the scrollable strip of products, wherein the dialog box provides product information and at least one purchase control, and wherein the ecommerce module is responsive to interaction with the purchase control to initiate a purchase transaction with the logged-in user through the user-interface.

8. The computer-based system of claim 7, wherein the purchase requests are conveyed by the communications module to the server for fulfillment.

9. The computer-based system of claim 8, wherein the purchases are fulfilled in an inventory-less manner.

10. The computer-based system of claim 1, wherein the user-interface further comprises a search box configured to capture a text string as the input and to compare the text string against the catalog data in the data cache or at the server and output one or more products that match all or part of the text string.
